(19) United States
(12) Patent Application Publication
(10) Pub. No.: US 2025/0321105 A1
(43) Pub. Date: Oct. 16, 2025

(54) INFORMATION PROCESSING DEVICE AND CONTROL METHOD

(71) Applicant: Mitsubishi Electric Corporation, TOKYO (JP)

(72) Inventors: Yohei MIKI, Tokyo (JP); Hideaki TERASHIMA, Tokyo (JP); Yoshiki MITSUI, Tokyo (JP); Shunya OSAWA, Tokyo (JP); Yoshie IMAI, Tokyo (JP); Satoru FURUTA, Tokyo (JP)

(73) Assignee: Mitsubishi Electric Corporation, TOKYO (JP)

(21) Appl. No.: 19/250,792

(22) Filed: Jun. 26, 2025

Related U.S. Application Data
(63) Continuation of application No. PCT/JP2023/016851, filed on Apr. 28, 2023.

(51) Int. Cl. G01C 21/20; G06Q 10/0833; G06Q 10/0835

(52) U.S. Cl. CPC G01C 21/20; G06Q 10/0833; G06Q 10/08355

(57) ABSTRACT

An information processing device includes an acquisition unit that acquires delivery position information, map information, speed information, and transshipment position information, a calculation unit that calculates a direct delivery time based on the delivery position information and so on and calculates a transshipment delivery time based on the delivery position information, the map information, and so on, and a control unit that executes control when the direct delivery time is shorter than the transshipment delivery time so that the first mobile object delivers the parcel from a start point to a delivery destination point and executes control when the transshipment delivery time is shorter than the direct delivery time so that the first mobile object moves to the transshipment position, the parcel is transshipped to the second mobile object and then the second mobile object moves to the delivery destination point.

### CROSS-REFERENCE TO RELATED APPLICATION

This application is a continuation application of International Application No. PCT/JP2023/016851 having an international filing date of Apr. 28, 2023, which is hereby expressly incorporated by reference into the present application.

### BACKGROUND OF THE INVENTION

### 1. Field of the Invention

The present disclosure relates to an information processing device and a control method.

### 2. Description of the Related Art

In recent years, autonomous delivery of parcels by robots has become a hot topic. For example, a technology regarding the autonomous delivery has been proposed (see Patent Reference 1). An information processing device in the Patent Reference 1 selects one out of a first delivery procedure of carrying a parcel from a pickup point to a delivery destination point by the same mobile object and a second delivery procedure of carrying the parcel from the pickup point to the delivery destination point by transshipping the parcel between/among a plurality of mobile objects and commands the delivery of the parcel by means of the selected delivery procedure.
Patent Reference 1: Japanese Patent Application Publication No. 2019-139264

In the above-described technology, direct delivery or transshipment delivery by one or more mobile objects having the same performance is selected. However, with the method selected by the above-described technology, there are cases where the delivery cannot be performed in a shortest time.

### SUMMARY OF THE INVENTION

An object of the present disclosure is to realize the delivery in the shortest time.

An information processing device according to an aspect of the present disclosure is provided. The information processing device includes an acquisition unit that acquires delivery position information indicating a start point where a first mobile object is situated and a delivery destination point, map information, speed information indicating speed of the first mobile object and speed of a second mobile object different from the first mobile object in performance, and transshipment position information indicating a first transshipment position, a calculation unit that calculates a delivery time as a direct delivery time based on the delivery position information, the map information and the speed of the first mobile object and calculates a transshipment delivery time, as a time for which delivery is performed by transshipping a parcel included in the first mobile object, based on the delivery position information, the map information, the speed of the first mobile object, the speed of the second mobile object, and the transshipment position information, and a control unit that executes control when the direct delivery time is shorter than the transshipment delivery time so that the first mobile object delivers the parcel from the start point to the delivery destination point and executes control when the transshipment delivery time is shorter than the direct delivery time so that the first mobile object moves to the first transshipment position, the parcel is transshipped to the second mobile object and then the second mobile object moves to the delivery destination point.

According to the present disclosure, the delivery in the shortest time can be realized.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a delivery system in a first embodiment;

FIG. 2 is an image diagram showing an example of road conditions in the first embodiment;

FIG. 3 is a diagram showing hardware included in an information processing device in the first embodiment;

FIG. 4 is a block diagram showing functions of the information processing device in the first embodiment;

FIG. 5 is a flowchart showing an example of a process executed by the information processing device in the first embodiment;

FIG. 6 is a diagram showing a concrete example of a process executed in the delivery system in the first embodiment;

FIG. 7 is a diagram showing an example of mobile object information in a second embodiment;

FIG. 8 is an image diagram showing an example of road conditions in the second embodiment;

FIG. 9 is a flowchart showing an example (part 1) of a process executed by an information processing device in the second embodiment;

FIG. 10 is a flowchart showing the example (part 2) of the process executed by the information processing device in the second embodiment;

FIG. 11 is a diagram showing a concrete example of a process executed in a delivery system in the second embodiment;

FIG. 12 is a diagram showing a concrete example of a process executed in a delivery system in a third embodiment;

FIG. 13 is a flowchart showing an example (part 1) of a process executed by an information processing device in the third embodiment;

FIG. 14 is a flowchart showing the example (part 2) of the process executed by the information processing device in the third embodiment;

FIG. 15 is a flowchart showing an example (part 1) of a process executed by an information processing device in a modification of the third embodiment;

FIG. 16 is a flowchart showing the example (part 2) of the process executed by the information processing device in the modification of the third embodiment;

FIG. 17 is a diagram showing a concrete example of a process executed in a delivery system in a fourth embodiment;

FIG. 18 is a flowchart showing an example (part 1) of a process executed by an information processing device in the fourth embodiment;

FIG. 19 is a flowchart showing the example (part 2) of the process executed by the information processing device in the fourth embodiment; and

FIG. 20 is a diagram showing a concrete example of a process executed in a delivery system in a fifth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

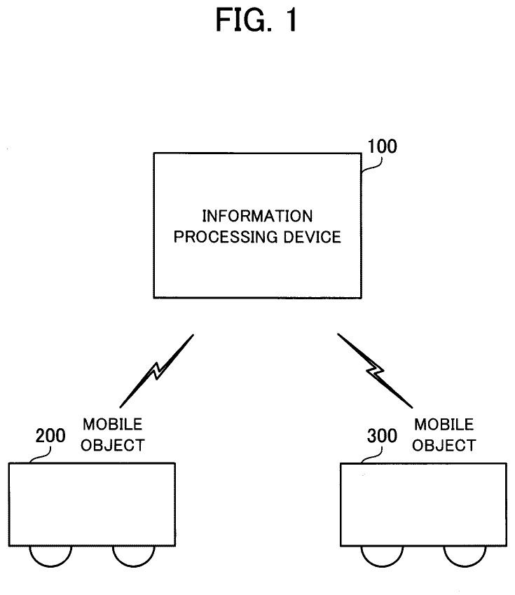

FIG. 1 is a diagram showing a delivery system in a first embodiment. The delivery system includes an information processing device 100, a mobile object 200 and a mobile object 300. The information processing device 100, the mobile object 200 and the mobile object 300 execute communication via a network.

The information processing device 100 is a device that executes a control method.

The mobile object 200 and the mobile object 300 deliver parcels. Further, the performance of the mobile object 200 and the performance of the mobile object 300 differ from each other. For example, the mobile object 200 and the mobile object 300 differ from each other in the speed that can be outputted. The mobile object 200 and the mobile object 300 may periodically transmit present position information to the information processing device 100. Here, the mobile object 200 is referred to also as a first mobile object. The mobile object 300 is referred to also as a second mobile object.

FIG. 1 shows two mobile objects. However, the number of mobile objects can also be three or more.

Next, an image diagram of road conditions on the delivery will be shown below.

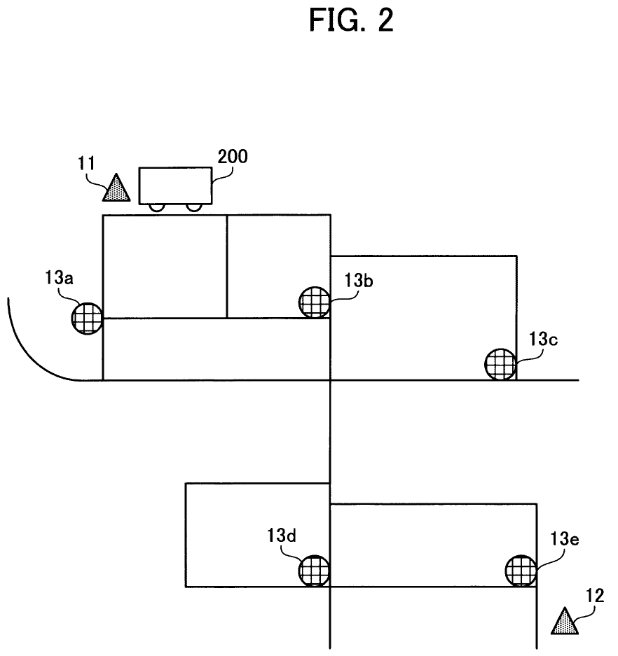

FIG. 2 is an image diagram showing an example of the road conditions in the first embodiment. FIG. 2 indicates a start point 11 and a delivery destination point 12. The mobile object 200 has been loaded with a parcel. Further, the mobile object 200 is situated at the start point 11. FIG. 2 indicates transshipment positions 13a to 13e. The mobile object 200 is capable of delivering the parcel from the start point 11 to the delivery destination point 12. Further, the parcel delivered by the mobile object 200 may also be transshipped to the mobile object 300 at a transshipment position.

Next, hardware included in the information processing device 100 will be described below.

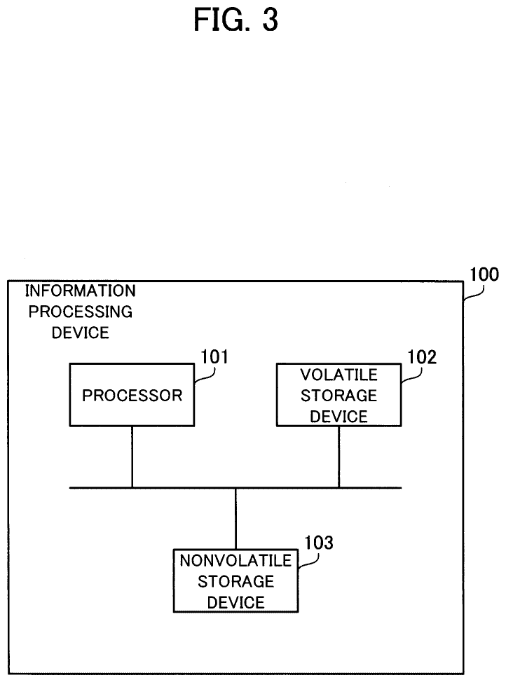

FIG. 3 is a diagram showing the hardware included in the information processing device in the first embodiment. The information processing device 100 is a computer. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions of the information processing device 100 will be described below.

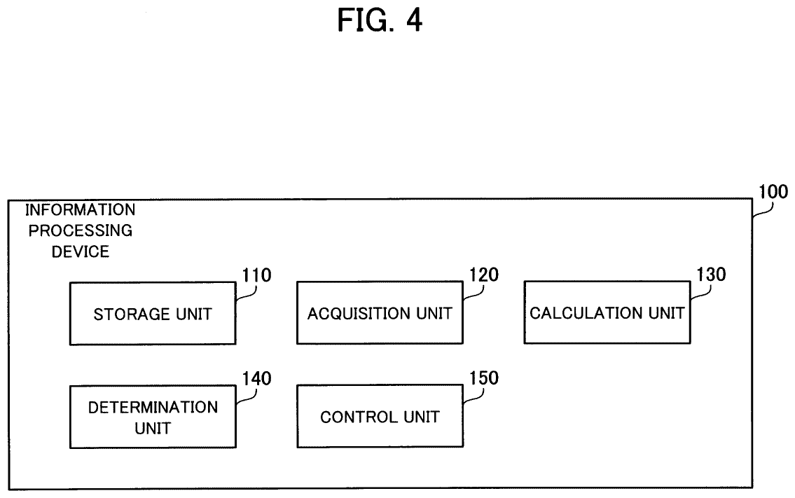

FIG. 4 is a block diagram showing the functions of the information processing device in the first embodiment. The information processing device 100 includes a storage unit 110, an acquisition unit 120, a calculation unit 130, a determination unit 140 and a control unit 150.

The storage unit 110 may be implemented as a storage area reserved in the volatile storage device 102 or the nonvolatile storage device 103.

Part or all of the acquisition unit 120, the calculation unit 130, the determination unit 140 and the control unit 150 may be implemented by processing circuitry. Further, part or all of the acquisition unit 120, the calculation unit 130, the determination unit 140 and the control unit 150 may be implemented as modules of a program executed by the processor 101. For example, the program executed by the processor 101 is referred to also as a control program. The control program has been recorded in a record medium, for example.

The storage unit 110 stores a variety of information.

Functions of the acquisition unit 120, the calculation unit 130, the determination unit 140 and the control unit 150 will be described later in detail.

Next, a process executed by the information processing device 100 will be described below by using a flowchart.

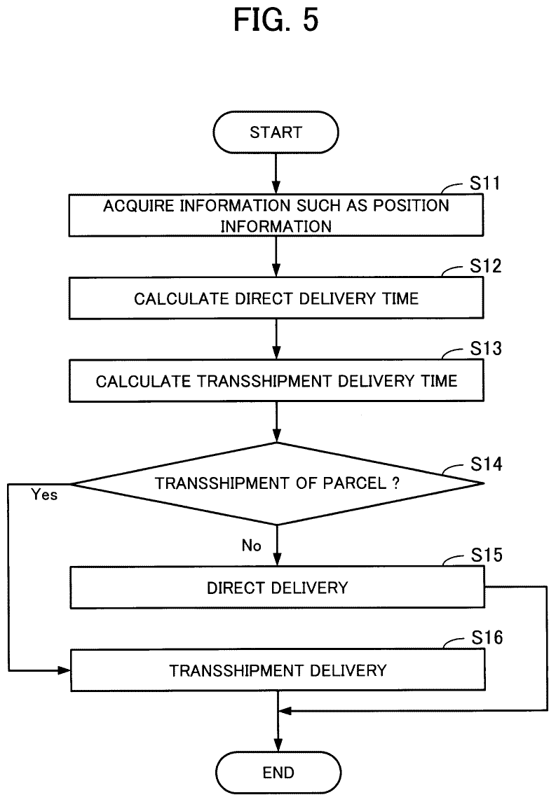

FIG. 5 is a flowchart showing an example of the process executed by the information processing device in the first embodiment.

(Step S11) The acquisition unit 120 acquires delivery position information indicating the start point and the delivery destination point, map information, speed information indicating speed of the mobile object 200 and speed of the mobile object 300, and transshipment position information indicating the transshipment positions. For example, the acquisition unit 120 acquires the delivery position information, the map information, the speed information and the transshipment position information from the storage unit 110. Alternatively, for example, the acquisition unit 120 acquires the delivery position information, the map information, the speed information and the transshipment position information from an external device. The external device is a cloud server, for example. Incidentally, illustration of the external device is left out.

(Step S12) The calculation unit 130 calculates a delivery time based on the delivery position information, the map information and the speed of the mobile object 200. For example, the calculation unit 130 calculates a route from the start point to the delivery destination point by using the delivery position information and the map information. The calculation unit 130 calculates the delivery time by using the route and the speed of the mobile object 200. Incidentally, this delivery time is referred to as a direct delivery time.

(Step S13) The calculation unit 130 calculates a transshipment delivery time, as a time for which the delivery is performed by transshipping the parcel included in the mobile object 200, based on the delivery position information, the map information and the speed of the mobile object 200, the speed of the mobile object 300, and the transshipment position information. It is assumed that one transshipment position is used, for example. This transshipment position may be referred to also as a first transshipment position. The calculation unit 130 calculates a pre-transshipment delivery time based on the distance of the route from the start point to the transshipment position and the speed of the mobile object 200. The calculation unit 130 calculates a post-transshipment delivery time based on the distance of the route from the transshipment position to the delivery destination point and the speed of the mobile object 300. The calculation unit 130 calculates the transshipment delivery time by adding up the pre-transshipment delivery time and the post-transshipment delivery time. Further, the calculation unit 130 may add a transshipment work time to the transshipment delivery time. By the addition of the transshipment work time, the information processing device 100 can obtain a more precise transshipment delivery time.

(Step S14) The determination unit 140 determines whether to perform the transshipment of the parcel or not based on the direct delivery time and the transshipment delivery time. The determination unit 140 determines not to perform the transshipment if the direct delivery time is shorter than the transshipment delivery time. The determination unit 140 determines to perform the transshipment if the transshipment delivery time is shorter than the direct delivery time. If the direct delivery time and the transshipment delivery time are equal to each other, the determination unit 140 may either determine to perform the transshipment or determine not to perform the transshipment.

When the transshipment is not performed, the process advances to step S15. When the transshipment is performed, the process advances to step S16.

(Step S15) The control unit 150 executes control so that the mobile object 200 delivers the parcel from the start point to the delivery destination point. Specifically, the control unit 150 generates route information indicating the route from the start point to the delivery destination point based on the delivery position information and the map information. The control unit 150 transmits the route information and a delivery command to the mobile object 200. Accordingly, the mobile object 200 performs the delivery based on the route information.

(Step S16) The control unit 150 executes control so that the mobile object 200 moves to the transshipment position, the parcel is transshipped to the mobile object 300 and then the mobile object 300 moves to the delivery destination point. Specifically, the control unit 150 generates pre-transshipment route information indicating the route from the start point to the transshipment position based on the start point, the transshipment position and the map information. The control unit 150 transmits the pre-transshipment route information and a movement command to the mobile object 200.

The control unit 150 generates post-transshipment route information indicating the route from the transshipment position to the delivery destination point based on the transshipment position, the delivery destination point and the map information. The control unit 150 transmits the post-transshipment route information and the movement command to the mobile object 300. Further, when the mobile object 300 is not situated at the transshipment position, the control unit 150 transmits the movement command to the mobile object 300 so that the mobile object 300 moves to the transshipment position.

Accordingly, the mobile object 200 moves to the transshipment position based on the pre-transshipment route information. The parcel is transshipped to the mobile object 300 at the transshipment position. After the transshipment of the parcel, the mobile object 300 moves to the delivery destination point based on the post-transshipment route information.

Incidentally, the transshipment work may be either performed by a human or performed by a machine. In the case where the transshipment is performed by a machine, the control unit 150 transmits a transshipment command to the mobile object 200 or the mobile object 300.

Next, a process executed in the delivery system will be described below by using a concrete example.

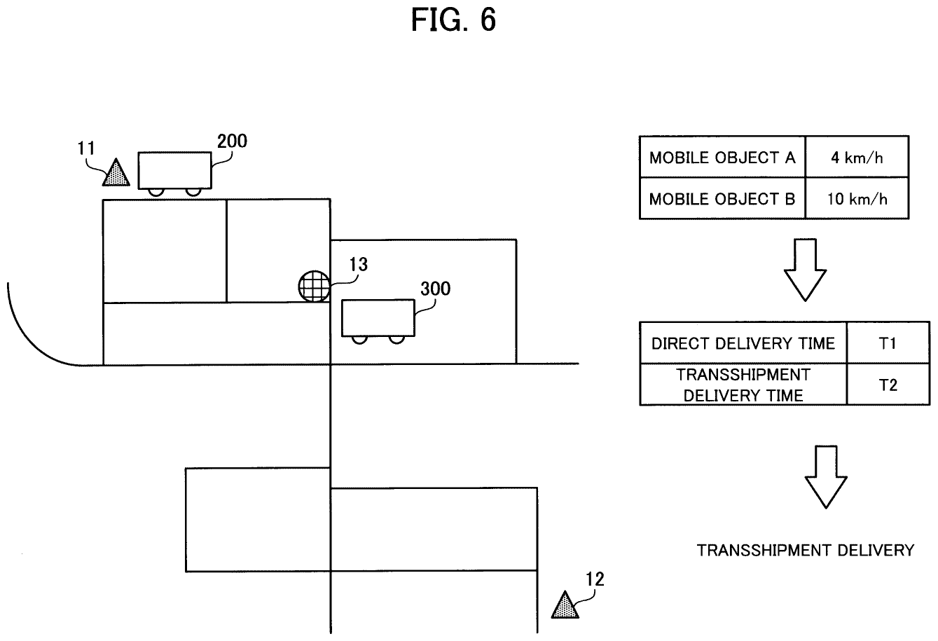

FIG. 6 is a diagram showing a concrete example of the process executed in the delivery system in the first embodiment. In the concrete example, it is assumed that one transshipment position is used for the simplicity of the explanation. Further, the speed of the mobile object 200 is assumed to be 4 km/h. The speed of the mobile object 300 is assumed to be 10 km/h. In the following description, the mobile object 200 can be referred to as a mobile object A. The mobile object 300 can be referred to as a mobile object B.

The information processing device 100 calculates the direct delivery time T1 based on the delivery position information, the map information and the speed of the mobile object 200.

The information processing device 100 calculates the transshipment delivery time T2, as a time for which the delivery is performed with transshipping the parcel at the transshipment position 13, based on the delivery position information, the map information, the speed of the mobile object 200, the speed of the mobile object 300, and the transshipment position information.

The transshipment delivery time T2 is assumed to be shorter than the direct delivery time T1. The information processing device 100 controls the mobile object 200 and the mobile object 300 so as to transship the parcel in the mobile object 200 to the mobile object 300 at the transshipment position 13. Further, the information processing device 100 controls the mobile object 300 so that the mobile object 300 delivers the parcel to the delivery destination point 12.

According to the first embodiment, the information processing device 100 determines a means for performing the delivery in the shortest time in consideration of the mobile objects differing in the performance. Accordingly, the information processing device 100 is capable of realizing the delivery in the shortest time.

The above description has been given of the case where one transshipment position is used. There may exist two or more transshipment positions as shown in FIG. 2. When there exist a plurality of transshipment positions, the transshipment position information indicates the plurality of transshipment positions. Then, in the step S13, the calculation unit 130 calculates a plurality of transshipment delivery times, as times in cases where the transshipment of the parcel is performed at a respective one of the plurality of transshipment positions, based on the delivery position information, the map information, the speed of the mobile object 200, the speed of the mobile object 300, and the transshipment position information. The determination unit 140 determines whether to perform the transshipment of the parcel or not based on the direct delivery time and the plurality of transshipment delivery times. Specifically, the determination unit 140 determines to perform the transshipment of the parcel if a time shorter than the direct delivery time exists among the plurality of transshipment delivery times. The control unit 150 executes control so that the transshipment of the parcel is performed at the transshipment position used when calculating the shortest transshipment delivery time among the plurality of transshipment delivery times. Specifically, the control unit 150 detects the shortest transshipment delivery time among the plurality of transshipment delivery times. The control unit 150 generates the pre-transshipment route information indicating the route from the start point to the transshipment position based on the transshipment position used when calculating the shortest transshipment delivery time, the start point, and the map information. The control unit 150 transmits the pre-transshipment route information and the movement command to the mobile object 200. The control unit 150 generates the post-transshipment route information indicating the route from the transshipment position to the delivery destination point based on the transshipment position, the delivery destination point and the map information. The control unit 150 transmits the post-transshipment route information and the movement command to the mobile object 300. Accordingly, in the delivery system, the delivery is performed in the shortest time. Incidentally, this transshipment position may be referred to also as the first transshipment position.

Further, when calculating the direct delivery time or the transshipment delivery time, the information processing device 100 may calculate the direct delivery time or the transshipment delivery time by using congestion information. The calculation process will be described in detail below. The acquisition unit 120 acquires the congestion information from the storage unit 110 or the external device. The congestion information is information indicating a correspondence relationship between each congestion area and a passage time as a time necessary for passing through the congestion area. When a part of the route used when calculating the direct delivery time is included in a congestion area, the calculation unit 130 uses the passage time as the time corresponding to the part of the route. Incidentally, this route is the route from the start point to the delivery destination point. When a part of the route used when calculating the transshipment delivery time is included in a congestion area, the calculation unit 130 uses the passage time as the time corresponding to the part of the route. Incidentally, this route is the route from the start point to the transshipment position plus the route from the transshipment position to the delivery destination point. As above, the information processing device 100 can obtain a more precise delivery time by using the passage time.

Furthermore, when the transshipment delivery time is calculated and there occurs a waiting time of the mobile object 200 or the mobile object 300, the calculation unit 130 may add the waiting time to the transshipment delivery time. The calculation process will be described in detail below. For example, the acquisition unit 120 acquires the present position information on the mobile object 200 and the present position information on the mobile object 300 from the storage unit 110 or the external device. If there is a difference between a time when the mobile object 200 arrives at the transshipment position and a time when the mobile object 300 arrives at the transshipment position based on the present position information on the mobile object 200, the present position information on the mobile object 300, the speeds of the mobile object 200 and the mobile object 300, the transshipment position information, and the map information, the calculation unit 130 adds the difference as the waiting time to the transshipment delivery time. As above, the information processing device 100 can obtain a more precise transshipment delivery time by adding the waiting time.

### Second Embodiment

Next, a second embodiment will be described below. In the second embodiment, the description will be given mainly of features different from those in the first embodiment. In the second embodiment, the description is omitted for features in common with the first embodiment.

In the second embodiment, the acquisition unit 120 acquires mobile object information from the storage unit 110 or the external device. Here, an example of the mobile object information will be shown below.

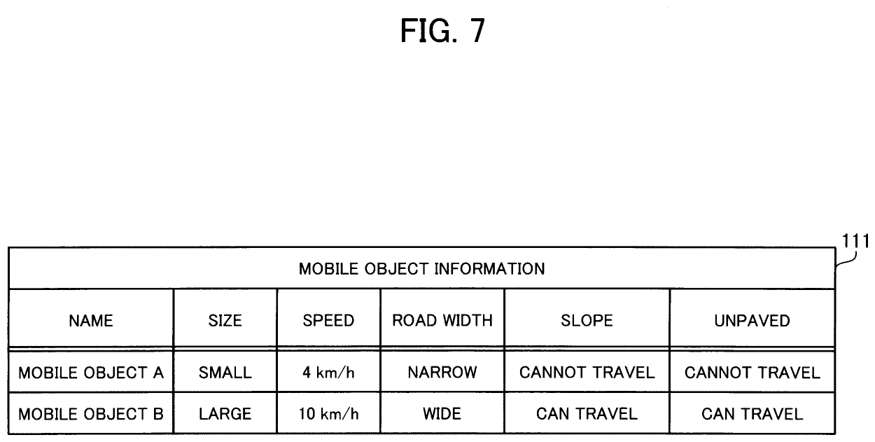

FIG. 7 is a diagram showing an example of the mobile object information in the second embodiment. The mobile object information 111 is stored in the storage unit 110, for example.

The mobile object information 111 includes at least one item of information out of a road width that each of the mobile object 200 and the mobile object 300 can pass through, information indicating whether or not each of the mobile object 200 and the mobile object 300 is capable of traveling through a part having a slope, and information indicating whether or not each of the mobile object 200 and the mobile object 300 is capable of traveling on an unpaved road.

For example, the mobile object information 111 includes items of name, size, speed, road width, slope, and unpaved. Incidentally, it is permissible even if the mobile object information 111 does not include the item of speed. The item of name indicates the name of each mobile object. The item of size indicates the size of each mobile object. In the item of speed, the maximum speed of each mobile object is registered. In the item of road width, the road width that each mobile object can pass through is registered. In the item of road width, a value indicating the road width may be registered. In the item of slope, information indicating whether or not each mobile object is capable of traveling through a part having a slope is registered. In the item of unpaved, information indicating whether or not each mobile object is capable of traveling on an unpaved road is registered.

As above, the mobile objects have various restrictions. Further, as shown in the mobile object information 111 in FIG. 7, the performance of the mobile object A (i.e., the mobile object 200) and the performance of the mobile object B (i.e., the mobile object 300) differ from each other.

Next, an example of the road conditions will be shown below.

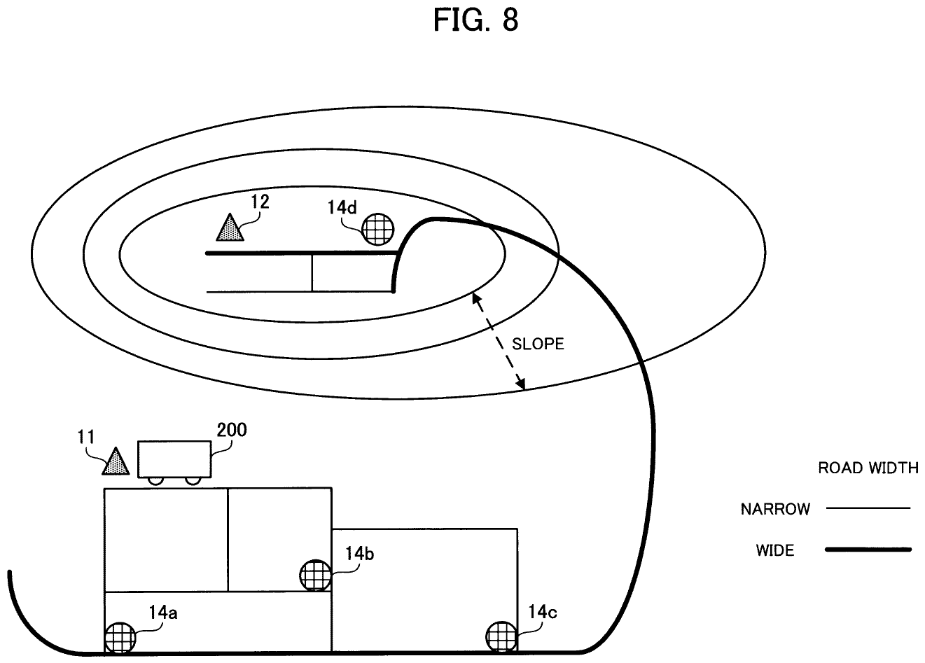

FIG. 8 is an image diagram showing an example of the road conditions in the second embodiment. FIG. 8 indicates the start point 11 and the delivery destination point 12. FIG. 8 indicates transshipment positions 14a to 14d.

FIG. 8 indicates that there are two types of road widths. The number of types of road widths can also be three or more. Further, FIG. 8 indicates that there is a part having a slope.

Since each mobile object has various restrictions, there are cases where the direct delivery cannot be performed in road conditions like those in FIG. 8. Therefore, the delivery system implements the delivery based on the restrictions on each mobile object and the road conditions. The information processing device 100 executes a process for implementing the delivery. The process of the information processing device 100 will be described below.

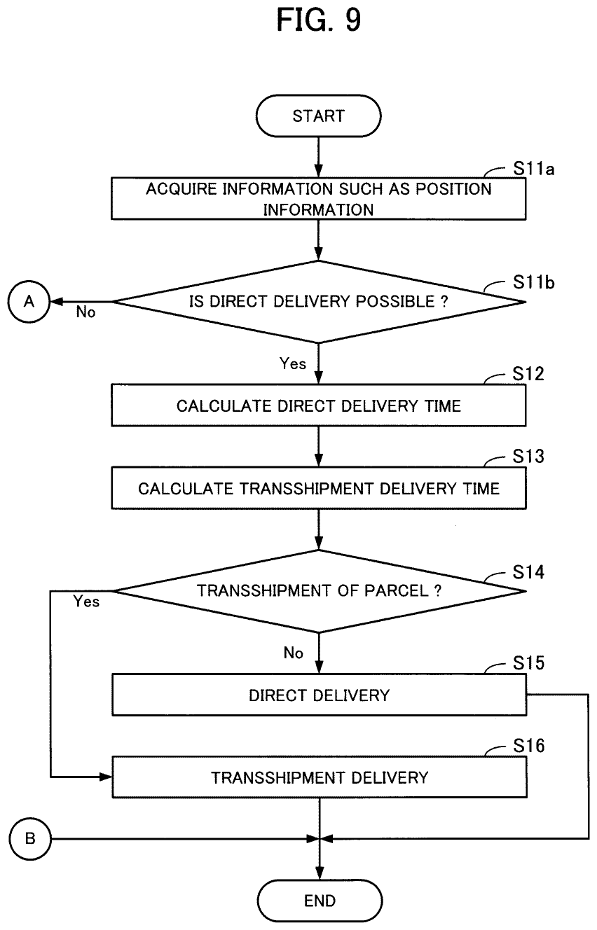

FIG. 9 is a flowchart showing an example (part 1) of the process executed by the information processing device in the second embodiment. The process in FIG. 9 differs from the process in FIG. 5 in that steps S11a and S11b are executed. Thus, the steps S11a and S11b in FIG. 9 will be described below. Then, the description will be omitted for processing other than the steps S11a and S11b.

(Step S11a) The acquisition unit 120 acquires the delivery position information indicating the start point and the delivery destination point, the map information, the mobile object information 111, and the transshipment position information indicating the transshipment positions from the storage unit 110 or the external device. Incidentally, the map information includes information regarding at least one out of the road width, the slope and the unpaved.

(Step S11b) The determination unit 140 determines whether the mobile object 200 is capable of delivering the parcel from the start point to the delivery destination point or not based on the delivery position information, the map information and the mobile object information 111. In other words, the determination unit 140 determines whether the mobile object 200 is capable of performing the direct delivery or not based on the restrictions on the mobile object 200 and the road conditions indicated by the map information.

When the mobile object 200 is capable of performing the direct delivery, the process advances to the step S12. When the mobile object 200 is incapable of performing the direct delivery, the control unit 150 executes control so that the transshipment delivery of the parcel is performed by the mobile object 200 and the mobile object 300. An example of the transshipment delivery will be described below. The process advances to step S21.

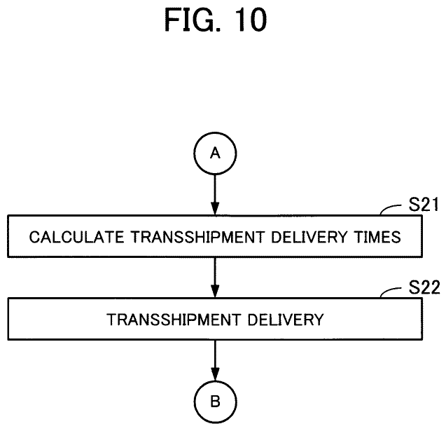

FIG. 10 is a flowchart showing the example (part 2) of the process executed by the information processing device in the second embodiment.

(Step S21) The calculation unit 130 calculates a plurality of transshipment delivery times, as times in cases where the transshipment of the parcel is performed, based on the delivery position information, the map information, the speed of the mobile object 200, the speed of the mobile object 300, the mobile object information 111, and the transshipment position information. The transshipment position information indicates a plurality of transshipment positions. Incidentally, when calculating the transshipment delivery times, the calculation unit 130 calculates the transshipment delivery times based on routes through which the delivery is necessarily possible by the mobile object 200 and the mobile object 300. In other words, the calculation unit 130 calculates the transshipment delivery times in consideration of the restrictions on the mobile objects indicated by the mobile object information 111.

(Step S22) The control unit 150 executes control so that the transshipment of the parcel is performed at the transshipment position used when calculating the shortest transshipment delivery time among the plurality of transshipment delivery times. Specifically, the control unit 150 generates the pre-transshipment route information indicating the route from the start point to the transshipment position based on the transshipment position, the start point and the map information. The control unit 150 transmits the pre-transshipment route information and the movement command to the mobile object 200. The control unit 150 generates the post-transshipment route information indicating the route from the transshipment position to the delivery destination point based on the transshipment position, the delivery destination point and the map information. The control unit 150 transmits the post-transshipment route information and the movement command to the mobile object 300. Incidentally, this transshipment position may be referred to also as the first transshipment position.

Next, a process executed in the delivery system will be described below by using a concrete example.

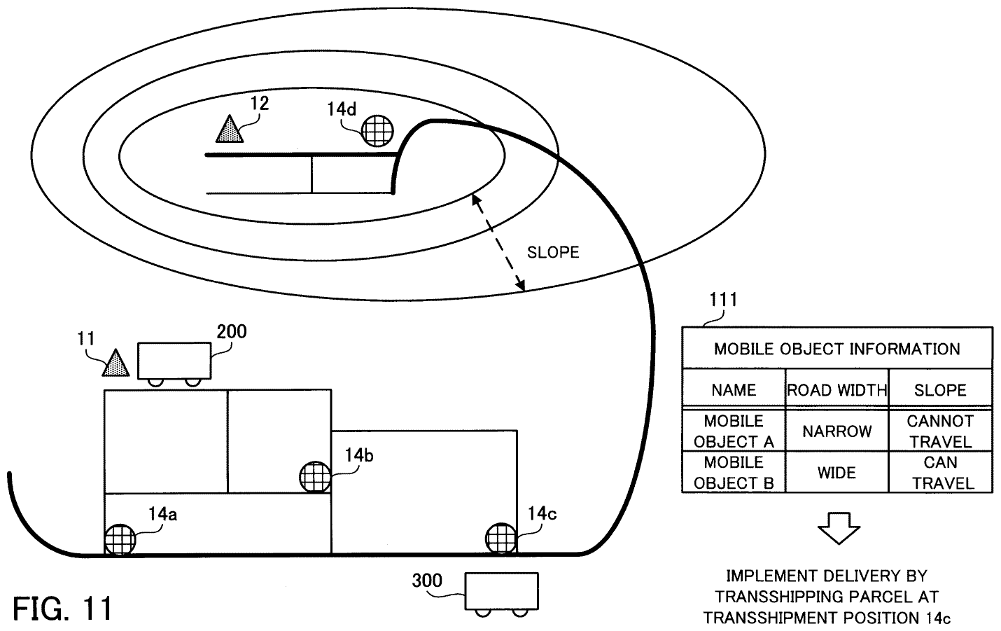

FIG. 11 is a diagram showing a concrete example of the process executed in the delivery system in the second embodiment. The information processing device 100 determines whether the mobile object 200 is capable of delivering the parcel from the start point to the delivery destination point or not based on the delivery position information, the map information and the mobile object information 111. When the mobile object 200 delivers the parcel from the start point 11 to the delivery destination point 12, the mobile object 200 needs to travel through a part having a slope. However, the mobile object 200 is incapable of traveling through a slope. Therefore, the information processing device 100 determines that the mobile object 200 is incapable of performing the direct delivery.

The information processing device 100 calculates the transshipment delivery times. Here, the mobile object 300 is incapable of moving to the transshipment position 14b since the road width is narrow in the vicinity of the transshipment position 14b. Therefore, the transshipment position 14b is excluded from the transshipment positions. Further, the mobile object 200 is incapable of moving to the transshipment position 14d. Therefore, the transshipment position 14d is excluded from the transshipment positions. Thus, the information processing device 100 calculates the transshipment delivery time in a case where the parcel is transshipped at the transshipment position 14a and the transshipment delivery time in a case where the parcel is transshipped at the transshipment position 14c. The transshipment delivery time in the case where the parcel is transshipped at the transshipment position 14c is assumed to be shorter than the transshipment delivery time in the case where the parcel is transshipped at the transshipment position 14a.

The information processing device 100 generates the pre-transshipment route information indicating the route from the start point 11 to the transshipment position 14c based on the start point 11, the transshipment position 14c and the map information. The information processing device 100 transmits the pre-transshipment route information and the movement command to the mobile object 200. The information processing device 100 generates the post-transshipment route information indicating the route from the transshipment position 14c to the delivery destination point 12 based on the transshipment position 14c, the delivery destination point and the map information. The information processing device 100 transmits the post-transshipment route information and the movement command to the mobile object 300.

According to the second embodiment, the information processing device 100 is capable of implementing the delivery of the parcel with reliability even when the mobile objects have restrictions.

Further, in the determination regarding the direct delivery, the information processing device 100 may execute the following process. The acquisition unit 120 acquires a payload of the parcel from the storage unit 110 or the external device. When a part having a slope exists between the start point and the delivery destination point, the mobile object is capable of traveling through a part having a slope, and the payload is greater than or equal to a predetermined threshold value, the determination unit 140 determines that the mobile object is incapable of delivering the parcel from the start point to the delivery destination point. By this, the information processing device 100 is capable of preventing the mobile object from rolling backward in a part having a slope.

### Third Embodiment

Next, a third embodiment will be described below. In the third embodiment, the description will be given mainly of features different from those in the first embodiment. In the third embodiment, the description is omitted for features in common with the first embodiment.

A process executed in the third embodiment will be briefly described below.

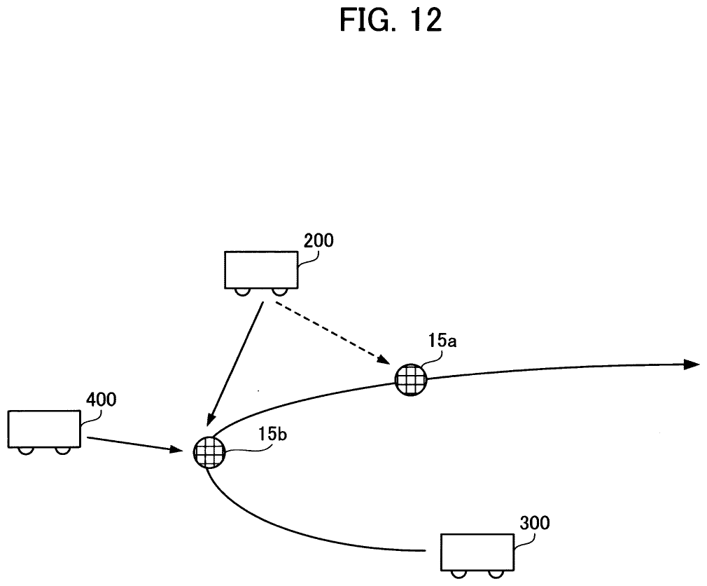

FIG. 12 is a diagram showing a concrete example of a process executed in a delivery system in the third embodiment. Similarly to the first embodiment, the information processing device 100 determines to transship the parcel in the mobile object 200 to the mobile object 300 at a transshipment position 15a. By this, it is scheduled that the parcel in the mobile object 200 will be transshipped to the mobile object 300 at the transshipment position 15a (e.g., the first transshipment position). Here, it is assumed that the information processing device 100 has previously determined to transship a parcel in a mobile object 400 to the mobile object 300 at a transshipment position 15b. If the mobile object 200 is capable of arriving at the transshipment position 15b before the mobile object 400 arrives at the transshipment position 15b, the information processing device 100 changes the transshipment position to the transshipment position 15b. Accordingly, the transshipment of two parcels is performed at the transshipment position 15b. Therefore, work efficiency is improved.

Next, a process executed by the information processing device 100 will be described below by using flowcharts.

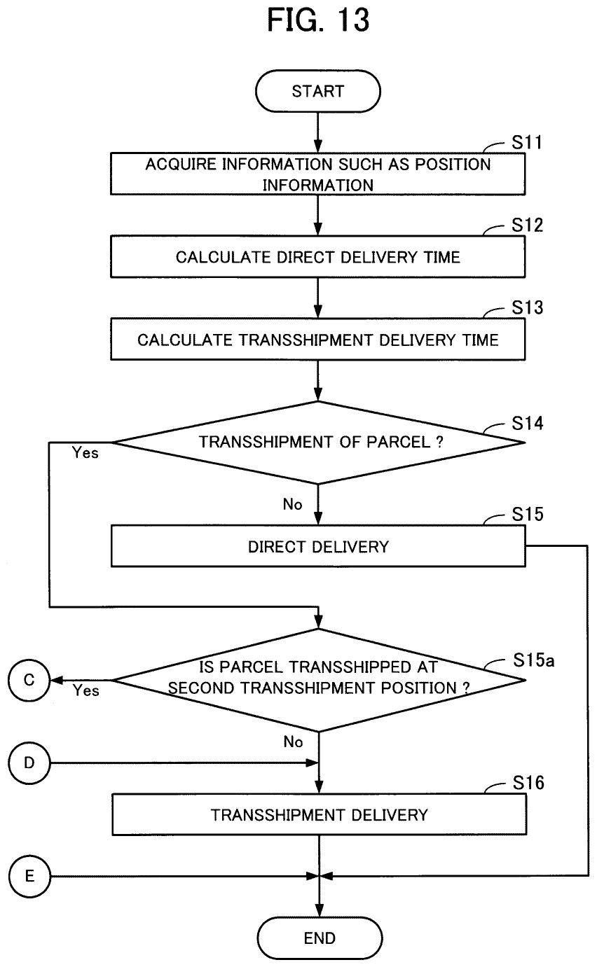

FIG. 13 is a flowchart showing an example (part 1) of the process executed by the information processing device in the third embodiment. The process in FIG. 13 differs from the process in FIG. 5 in that step S15a is executed. Thus, the step S15a in FIG. 13 will be described below. Then, the description will be omitted for processing other than the step S15a.

(Step S15a) The determination unit 140 determines whether or not the parcel in a third mobile object (e.g., the mobile object 400) can be transshipped to the mobile object 300 at a second transshipment position (e.g., the transshipment position 15b). For example, if the storage unit 110 has stored information indicating that the parcel in the third mobile object can be transshipped to the mobile object 300 at the second transshipment position, the determination unit 140 determines that the parcel in the third mobile object can be transshipped to the mobile object 300 at the second transshipment position.

When the transshipment of the parcel is performed at the second transshipment position, the process advances to step S31. When the transshipment of the parcel is not performed at the second transshipment position, the process advances to the step S16.

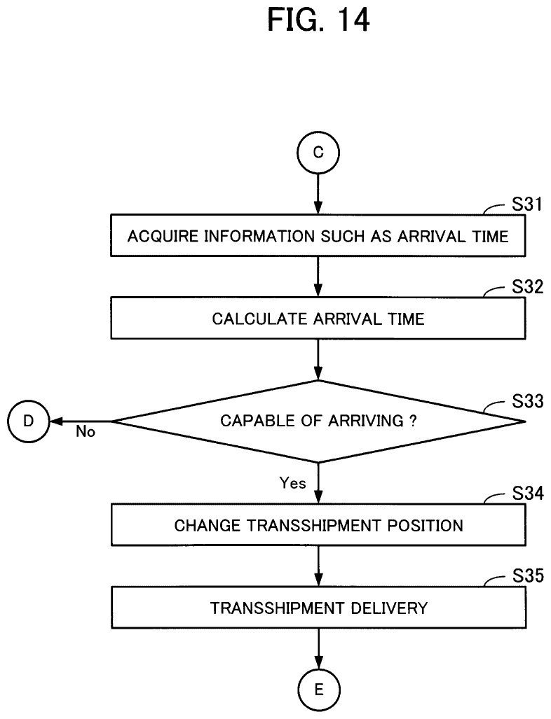

FIG. 14 is a flowchart showing the example (part 2) of the process executed by the information processing device in the third embodiment.

(Step S31) The acquisition unit 120 acquires an arrival time when the third mobile object arrives at the second transshipment position. For example, the acquisition unit 120 acquires the arrival time from the storage unit 110 or the external device. Further, the acquisition unit 120 acquires information on the second transshipment position from the storage unit 110 or the external device.

(Step S32) The calculation unit 130 calculates an arrival time when the mobile object 200 arrives at the second transshipment position based on the present position of the mobile object 200 as the start point, the second transshipment position, the map information, and the speed of the mobile object 200. Incidentally, the acquisition unit 120 may acquire the present position information on the mobile object 200. For example, the acquisition unit 120 acquires the present position information on the mobile object 200 from the storage unit 110 or the mobile object 200.

(Step S33) The determination unit 140 determines whether the mobile object 200 is capable of arriving at the second transshipment position before the third mobile object arrives at the second transshipment position or not based on the arrival time acquired in the step S31 and the arrival time calculated in the step S32. If the condition is satisfied, the process advances to step S34. If the condition is not satisfied, the process advances to the step S16.

(Step S34) The control unit 150 changes the first transshipment position to the second transshipment position.

(Step S35) The control unit 150 executes control so that the parcel in the mobile object 200 is transshipped to the mobile object 300 at the second transshipment position. Specifically, the control unit 150 generates the pre-transshipment route information indicating the route from the start point to the second transshipment position based on the start point, the second transshipment position and the map information. The control unit 150 transmits the pre-transshipment route information and the movement command to the mobile object 200.

The control unit 150 generates route information based on the delivery destination point of the parcel in the mobile object 200, the delivery destination point of the parcel in the third mobile object, and the map information. The control unit 150 transmits the route information and the movement command to the mobile object 300.

According to the third embodiment, the information processing device 100 is capable of improving the work efficiency.

### Modification of Third Embodiment

The third embodiment may be combined with the second embodiment. Flowcharts in the case where the second embodiment and the third embodiment are combined together will be shown below.

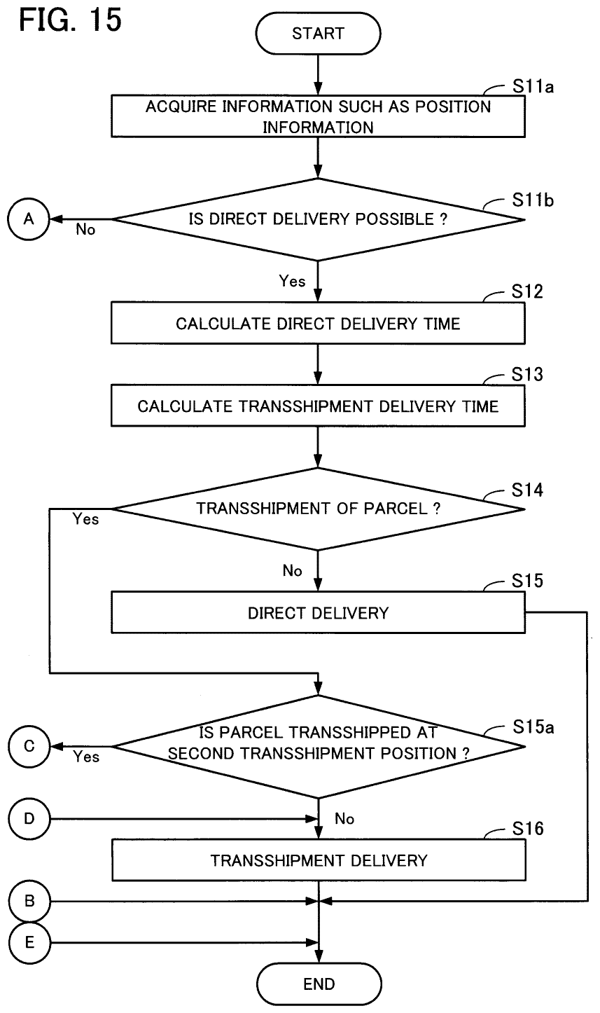

FIG. 15 is a flowchart showing an example (part 1) of a process executed by an information processing device in a modification of the third embodiment. The process in FIG. 15 is a combination of the process in FIG. 5, the process in FIG. 9 and the process in FIG. 13. Therefore, the description of the process in FIG. 15 is left out.

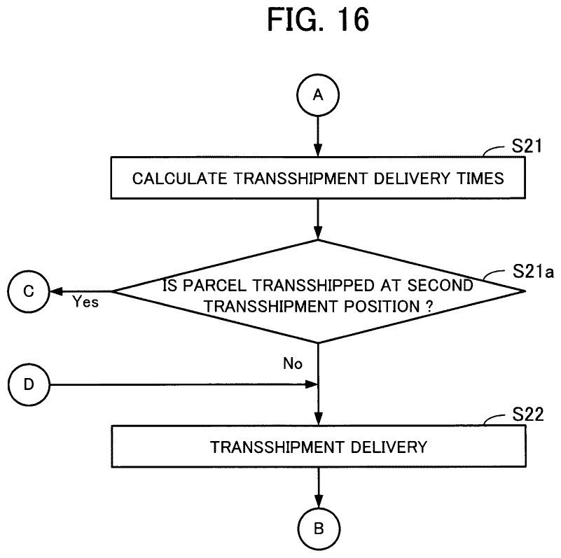

FIG. 16 is a flowchart showing the example (part 2) of the process executed by the information processing device in the modification of the third embodiment. The process in FIG. 16 differs from the process in FIG. 10 in that step S21a is executed. Thus, the step S21a in FIG. 16 will be described below. Then, the description will be omitted for processing other than the step S21a.

(Step S21a) The determination unit 140 determines whether or not the parcel in the third mobile object can be transshipped to the mobile object 300 at the second transshipment position.

When the transshipment of the parcel is performed at the second transshipment position, the process advances to the step S31. When the transshipment of the parcel is not performed at the second transshipment position, the process advances to the step S22.

Incidentally, if No in the step S33 after Yes in the step S15a, the process advances to the step S16. If No in the step S33 after Yes in the step S21a, the process advances to the step S22.

According to the modification of the third embodiment, the information processing device 100 is capable of improving the work efficiency.

### Fourth Embodiment

Next, a fourth embodiment will be described below. In the fourth embodiment, the description will be given mainly of features different from those in the first embodiment. In the fourth embodiment, the description is omitted for features in common with the first embodiment.

A process executed in the fourth embodiment will be briefly described below.

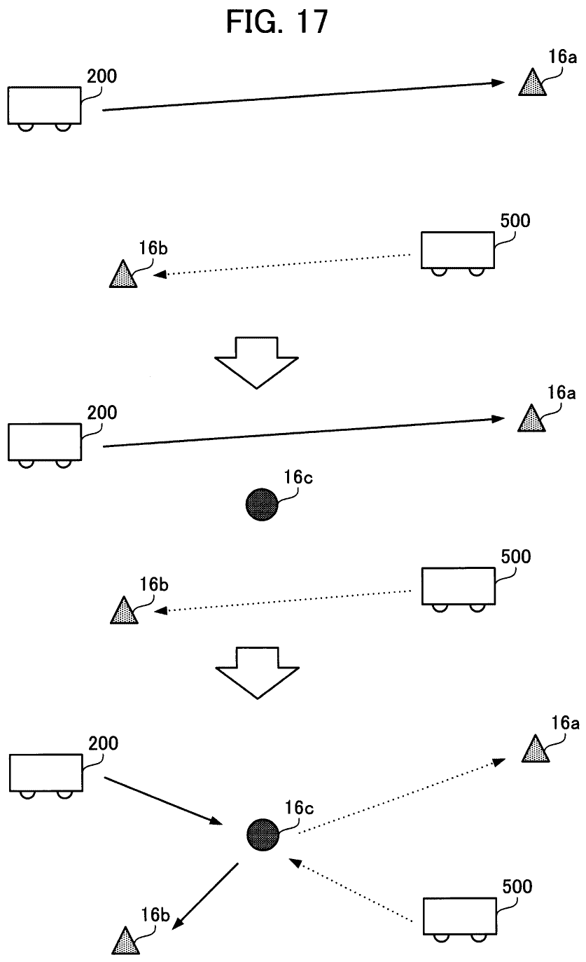

FIG. 17 is a diagram showing a concrete example of a process executed in a delivery system in the fourth embodiment. Similarly to the first embodiment, the information processing device 100 determines that the mobile object 200 performs direct delivery. Additionally, the delivery destination is a delivery destination 16a. Here, it is assumed that it has previously been determined that a mobile object 500 performs direct delivery. Additionally, the delivery destination is a delivery destination 16b. When the distance between the mobile object 200 and the delivery destination 16b is shorter than the distance between the mobile object 200 and the delivery destination 16a, the information processing device 100 determines an exchange position 16c of parcels. The information processing device 100 controls the mobile object 200 and the mobile object 500 so as to exchange the parcels at the exchange position 16c. Accordingly, the parcel in the mobile object 200 and the parcel in the mobile object 500 are exchanged with each other at the exchange position 16c. As above, the information processing device 100 is capable of shortening the travel distance of the mobile object 200.

Next, a process executed by the information processing device 100 will be described below by using flowcharts.

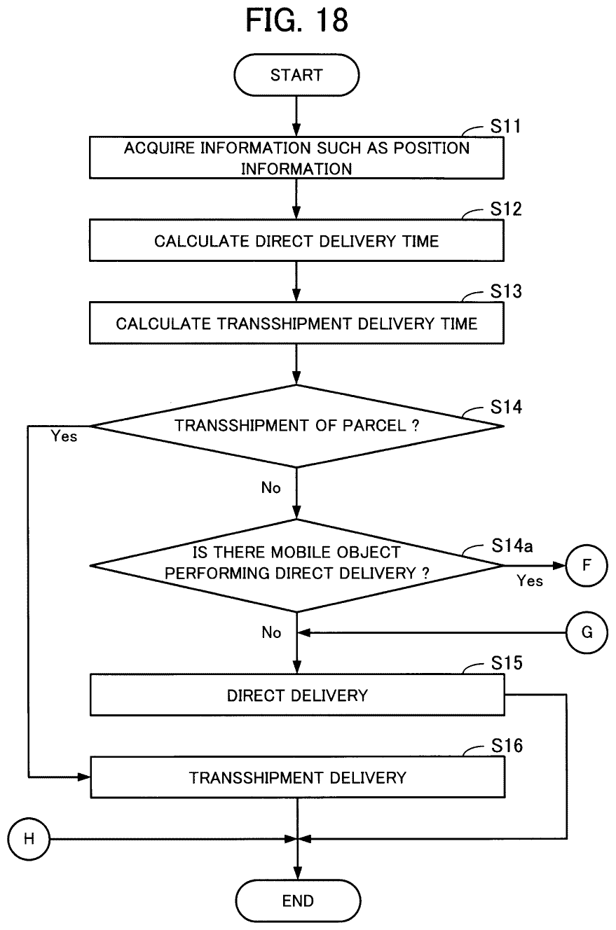

FIG. 18 is a flowchart showing an example (part 1) of the process executed by the information processing device in the fourth embodiment. The process in FIG. 18 differs from the process in FIG. 5 in that step S14a is executed. Thus, the step S14a in FIG. 18 will be described below. Then, the description will be omitted for processing other than the step S14a.

(Step S14a) The determination unit 140 determines whether or not there exists a mobile object (hereinafter referred to as a fourth mobile object) performing the direct delivery. For example, if the storage unit 110 has stored information indicating that a fourth mobile object is performing the direct delivery, the determination unit 140 determines that there exists a fourth mobile object performing the direct delivery.

If there exists a fourth mobile object performing the direct delivery, the process advances to step S41. If there exists no fourth mobile object performing the direct delivery, the process advances to the step S15.

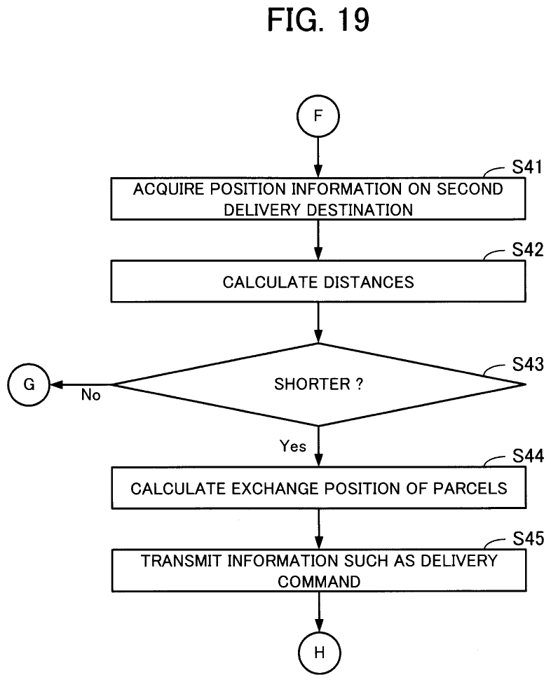

FIG. 19 is a flowchart showing the example (part 2) of the process executed by the information processing device in the fourth embodiment.

(Step S41) The acquisition unit 120 acquires position information on the delivery destination point (hereinafter referred to as a second delivery destination) of the parcel included in the fourth mobile object from the storage unit 110 or the external device.

(Step S42) The calculation unit 130 calculates the distance (hereinafter referred to as a first distance) between the mobile object 200 and the delivery destination point (referred to as a first delivery destination, for example) indicated by the delivery position information based on the present position of the mobile object 200 as the start point and the first delivery destination. The calculation unit 130 calculates the distance (hereinafter referred to as a second distance) between the mobile object 200 and the second delivery destination based on the present position of the mobile object 200 and the position information on the second delivery destination. Incidentally, the acquisition unit 120 may acquire the present position information on the mobile object 200. For example, the acquisition unit 120 acquires the present position information on the mobile object 200 from the storage unit 110 or the mobile object 200.

(Step S43) The determination unit 140 determines whether or not the second distance is shorter than the first distance. If the condition is satisfied, the process advances to step S44. If the condition is not satisfied, the process advances to the step S15.

(Step S44) The calculation unit 130 calculates the exchange position of the parcels by using the map information. For example, the calculation unit 130 calculates the exchange position of the parcels based on the map information and the position information on the second delivery destination. The exchange position of the parcels may also be calculated as follows. The acquisition unit 120 acquires the present position information on the fourth mobile object from the storage unit 110 or the fourth mobile object. The calculation unit 130 calculates an intermediate position between the mobile object 200 and the fourth mobile object as the exchange position of the parcels by using the map information, the present position information on the mobile object 200, and the present position information on the fourth mobile object.

(Step S45) The control unit 150 executes control so that the mobile object 200 moves to the exchange position and the mobile object 200 moves to the second delivery destination after the parcels are exchanged. Specifically, the control unit 150 generates route information based on the start point, the exchange position of the parcels, the second delivery destination and the map information. The control unit 150 transmits the route information and the delivery command to the mobile object 200.

Further, the control unit 150 generates route information based on the present position information on the fourth mobile object, the exchange position of the parcels, the first delivery destination, and the map information. The control unit 150 transmits the route information and the movement command to the fourth mobile object.

Accordingly, the mobile object 200 moves from the start point to the exchange position of the parcels. The fourth mobile object moves from the present position on the fourth mobile object to the exchange position of the parcels. After the exchange of the parcels is performed, the mobile object 200 moves to the second delivery destination. Further, after the exchange of the parcels is performed, the fourth mobile object moves to the first delivery destination. Incidentally, the exchange of the parcels may be either performed by a human or performed by a machine. In the case where the exchange of the parcels is performed by a machine, the control unit 150 transmits a parcel exchange command to the mobile object 200 and the fourth mobile object.

According to the fourth embodiment, the information processing device 100 is capable of shortening the travel distance of the mobile object 200.

### Fifth Embodiment

Next, a fifth embodiment will be described below. In the fifth embodiment, the description will be given mainly of features different from those in the first embodiment. In the fifth embodiment, the description is omitted for features in common with the first embodiment.

A process executed in the fifth embodiment will be described below by using a diagram.

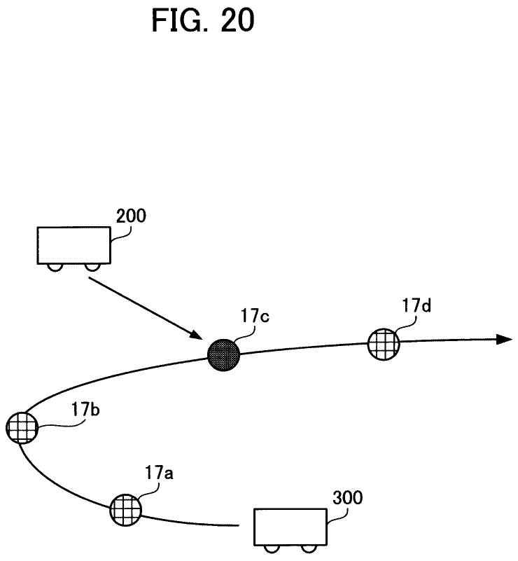

FIG. 20 is a diagram showing a concrete example of a process executed in a delivery system in the fifth embodiment. FIG. 20 indicates the mobile object 300. In the fifth embodiment, the mobile object 300 is a bus. Further, FIG. 20 indicates transshipment positions 17a to 17d. The transshipment positions 17a to 17d are bus stops.

Similarly to the first embodiment, the information processing device 100 determines to perform the transshipment of a parcel (Yes in the step S14).

The acquisition unit 120 acquires information indicating a bus stop where the user rides on or gets off the bus from the storage unit 110 or the external device. Here, for example, when the user riding on the mobile object 300 presses a stop button to get off, the mobile object 300 transmits information indicating a bus stop at which the mobile object 300 stops next (i.e., information indicating a bus stop where the user gets off) to the information processing device 100 or the external device. Further, for example, when a communication device installed in a bus stop detects the user in an image generated by a camera connected to the communication device, the communication device transmits information indicating the bus stop where the user rides on the bus to the information processing device 100 or the external device. As above, the information indicating a bus stop where the user rides on or gets off the bus is transmitted to the information processing device 100 or the external device and thereby stored in the storage unit 110 or the external device.

The control unit 150 determines the bus stop as the transshipment position based on the information indicating the bus stop where the user rides on or gets off the bus. For example, when the bus stop is the transshipment position 17c, the control unit 150 determines the transshipment position 17c as the transshipment position. Incidentally, the determined transshipment position is referred to also as the first transshipment position.

The control unit 150 generates the pre-transshipment route information indicating the route from the start point to the transshipment position based on the start point, the transshipment position and the map information. The control unit 150 transmits the pre-transshipment route information and the delivery command to the mobile object 200.

The control unit 150 transmits information indicating the delivery destination point to the mobile object 300. Incidentally, the delivery destination point is the bus stop.

According to the fifth embodiment, the information processing device 100 is capable of realizing efficient operation of buses and the delivery of parcels.

Features in the embodiments described above can be appropriately combined with each other.

### DESCRIPTION OF REFERENCE CHARACTERS

11: start point, 12: delivery destination point, 13, 13a-13e: transshipment position, 14a-14d: transshipment position, 15a, 15b: transshipment position, 16a, 16b: delivery destination, 16c: exchange position, 17a-17d: transshipment position, 100: information processing device, 101: processor, 102: volatile storage device, 103: nonvolatile storage device, 110: storage unit, 111: mobile object information, 120: acquisition unit, 130: calculation unit, 140: determination unit, 150: control unit, 200: mobile object, 300: mobile object, 400: mobile object, 500: mobile object

What is claimed is:

1. An information processing device comprising:
acquiring circuitry to acquire delivery position information indicating a start point where a first mobile object is situated and a delivery destination point, map information, speed information indicating speed of the first mobile object and speed of a second mobile object different from the first mobile object in performance, and transshipment position information indicating a first transshipment position;
calculating circuitry to calculate a delivery time as a direct delivery time based on the delivery position information, the map information and the speed of the first mobile object and calculate a transshipment delivery time, as a time for which delivery is performed by transshipping a parcel included in the first mobile object, based on the delivery position information, the map information, the speed of the first mobile object, the speed of the second mobile object, and the transshipment position information; and
controlling circuitry to execute control when the direct delivery time is shorter than the transshipment delivery time so that the first mobile object delivers the parcel from the start point to the delivery destination point and execute control when the transshipment delivery time is shorter than the direct delivery time so that the first mobile object moves to the first transshipment position, the parcel is transshipped to the second mobile object and then the second mobile object moves to the delivery destination point.

2. The information processing device according to claim 1, wherein
the transshipment position information indicates a plurality of transshipment positions,
the calculating circuitry calculates a plurality of transshipment delivery times, as times in cases where the transshipment of the parcel is performed at a respective one of the plurality of transshipment positions, based on the delivery position information, the map information, the speed of the first mobile object, the speed of the second mobile object, and the transshipment position information, and
when a time shorter than the direct delivery time exists among the plurality of transshipment delivery times, the controlling circuitry executes control so that the transshipment of the parcel is performed at the transshipment position used when calculating a shortest transshipment delivery time among the plurality of transshipment delivery times.

3. The information processing device according to claim 1, further comprising determining circuitry, wherein
the acquiring circuitry acquires mobile object information including at least one item of information out of a road width that each of the first mobile object and the second mobile object can pass through, information indicating whether or not each of the first mobile object and the second mobile object is capable of traveling through a part having a slope, and information indicating whether or not each of the first mobile object and the second mobile object is capable of traveling on an unpaved road,
the map information includes information regarding at least one out of the road width, the slope and the unpaved,
the determining circuitry determines whether the first mobile object is capable of delivering the parcel from the start point to the delivery destination point or not based on the delivery position information, the map information and the mobile object information, and
when the first mobile object is incapable of delivering the parcel from the start point to the delivery destination point, the controlling circuitry executes control so that the transshipment delivery of the parcel is performed by the first mobile object and the second mobile object.

4. The information processing device according to claim 3, wherein
the transshipment position information indicates a plurality of transshipment positions,
when the first mobile object is incapable of delivering the parcel from the start point to the delivery destination point, the calculating circuitry calculates a plurality of transshipment delivery times, as times in cases where the transshipment of the parcel is performed, based on the delivery position information, the map information, the speed of the first mobile object, the speed of the second mobile object, the mobile object information, and the transshipment position information, and
the controlling circuitry executes control so that the transshipment of the parcel is performed at the transshipment position used when calculating a shortest transshipment delivery time among the plurality of transshipment delivery times.

5. The information processing device according to claim 3, wherein
the acquiring circuitry acquires a payload of the parcel, and
when a part having a slope exists between the start point and the delivery destination point, the first mobile object is capable of traveling through a part having a slope, and the payload is greater than or equal to a predetermined threshold value, the determining circuitry determines that the first mobile object is incapable of delivering the parcel from the start point to the delivery destination point.

6. The information processing device according to claim 1, wherein when the transshipment delivery time is calculated and there occurs a waiting time of the first mobile object or the second mobile object, the calculating circuitry adds the waiting time to the transshipment delivery time.

7. The information processing device according to claim 1, wherein
when the parcel in the first mobile object is scheduled to be transshipped to the second mobile object at the first transshipment position and a parcel in a third mobile object is transshipped to the second mobile object at a second transshipment position, the acquiring circuitry acquires an arrival time when the third mobile object arrives at the second transshipment position,
the calculating circuitry calculates an arrival time when the first mobile object arrives at the second transshipment position based on a present position of the first mobile object as the start point, the second transshipment position, the map information, and the speed of the first mobile object, and
when the first mobile object is capable of arriving at the second transshipment position before the third mobile object arrives at the second transshipment position based on the acquired arrival time and the calculated arrival time, the controlling circuitry executes control so that the parcel in the first mobile object is transshipped to the second mobile object at the second transshipment position.

8. The information processing device according to claim 1, wherein
when the first mobile object performs direct delivery and there exists a fourth mobile object performing direct delivery, the acquiring circuitry acquires position information on a second delivery destination as a delivery destination point of a parcel included in the fourth mobile object,
the calculating circuitry calculates a first distance as a distance between the first mobile object and a first delivery destination as the delivery destination point indicated by the delivery position information based on a present position of the first mobile object as the start point and the first delivery destination, calculates a second distance as a distance between the first mobile object and the second delivery destination based on the present position of the first mobile object and the position information on the second delivery destination, and when the second distance is shorter than the first distance, calculates an exchange position of the parcels by using the map information, and
the controlling circuitry executes control so that the first mobile object moves to the exchange position and the first mobile object after exchange of the parcels moves to the second delivery destination.

9. The information processing device according to claim 1, wherein
the acquiring circuitry acquires congestion information as information indicating a correspondence relationship between each congestion area and a passage time as a time necessary for passing through the congestion area, and
when a part of a route used when calculating the direct delivery time or the transshipment delivery time is included in the congestion area, the calculating circuitry uses the passage time as a time corresponding to the part of the route.

10. The information processing device according to claim 1, wherein
the second mobile object is a bus,
when the transshipment of the parcel is performed, the acquiring circuitry acquires information indicating a bus stop where a user rides on or gets off the bus, and
the controlling circuitry determines the bus stop as the first transshipment position based on the information indicating the bus stop where the user rides on or gets off the bus.

11. The information processing device according to claim 1, wherein the calculating circuitry adds a transshipment work time to the transshipment delivery time.

12. A control method performed by an information processing device, the control method comprising:
acquiring delivery position information indicating a start point where a first mobile object is situated and a delivery destination point, map information, speed information indicating speed of the first mobile object and speed of a second mobile object different from the first mobile object in performance, and transshipment position information indicating a first transshipment position;
calculating a delivery time as a direct delivery time based on the delivery position information, the map information and the speed of the first mobile object and calculating a transshipment delivery time, as a time for which delivery is performed by transshipping a parcel included in the first mobile object, based on the delivery position information, the map information, the speed of the first mobile object, the speed of the second mobile object, and the transshipment position information; and
executing control when the direct delivery time is shorter than the transshipment delivery time so that the first mobile object delivers the parcel from the start point to the delivery destination point and executing control when the transshipment delivery time is shorter than the direct delivery time so that the first mobile object moves to the first transshipment position, the parcel is transshipped to the second mobile object and then the second mobile object moves to the delivery destination point.

13. An information processing device comprising:
a processor to execute a program; and
a memory to store the program which, when executed by the processor, performs processes of,
acquiring delivery position information indicating a start point where a first mobile object is situated and a delivery destination point, map information, speed information indicating speed of the first mobile object and speed of a second mobile object different from the first mobile object in performance, and transshipment position information indicating a first transshipment position,
calculating a delivery time as a direct delivery time based on the delivery position information, the map information and the speed of the first mobile object and calculating a transshipment delivery time, as a time for which delivery is performed by transshipping a parcel included in the first mobile object, based on the delivery position information, the map information, the speed of the first mobile object, the speed of the second mobile object, and the transshipment position information, and
executing control when the direct delivery time is shorter than the transshipment delivery time so that the first mobile object delivers the parcel from the start point to the delivery destination point and executing control when the transshipment delivery time is shorter than the direct delivery time so that the first mobile object moves to the first transshipment position, the parcel is transshipped to the second mobile object and then the second mobile object moves to the delivery destination point.
